(19) United States
(12) Patent Application Publication
(10) Pub. No.: US 2026/0115962 A1
(43) Pub. Date: Apr. 30, 2026

(54) ACCUMULATION DEVICE AND METHOD FOR PRODUCING FIBER BODY

(71) Applicant: SEIKO EPSON CORPORATION, Tokyo (JP)

(72) Inventors: Hayata KOBAYASHI, Suwa (JP); Takahiko UCHIDA, Hara-mura (JP)

(21) Appl. No.: 19/369,420

(22) Filed: Oct. 27, 2025

(30) Foreign Application Priority Data
Oct. 28, 2024 (JP) 2024-188834

(51) Int. Cl. B27N 3/04

(52) U.S. Cl. CPC B27N 3/04

(57) ABSTRACT

An accumulation device includes: a supply pipe for supplying a material containing fibers; a chamber for dispersing the material supplied from the supply pipe in air; an accumulating member for accumulating the material dispersed in the air to generate an accumulated material; and a suction section for sucking the air through the accumulating member. The chamber includes: a supply port to which the supply pipe is coupled; an outside air intake port for taking in outside air; and a wind direction plate for changing a flow of the outside air taken in from the outside air intake port.

The present application is based on, and claims priority from JP Application Serial Number 2024-188834, filed Oct. 28, 2024, the disclosure of which is hereby incorporated by reference herein in its entirety.

### BACKGROUND

### 1. Technical Field

The present disclosure relates to an accumulation device and a method for producing a fiber body.

### 2. Related Art

As described in JP-A-2019-143256, there is known a fiber body manufacturing apparatus including a crushing section that crushes a waste paper sheet, a defibrating section that defibrates a crushed piece obtained by the crushing section, an accumulation section for accumulating a defibrated material obtained by the defibrating section on a flat surface, a heating/pressurization section that heats and pressurizes an accumulated web, a cutting section that cuts a sheet obtained by the heating/pressurization section into a predetermined shape, and a sheet collection section that collects the obtained sheet.

The accumulation section provided in the fiber body manufacturing apparatus of JP-A-2019-143256 includes a material discharge section that discharges the defibrated material, a mesh belt on which a material is accumulated from the material discharge section via air, and a suction section that suctions the defibrated material accumulated on the mesh belt via the mesh belt. The suction section can be displaced with respect to the mesh belt, and is provided with wind direction plates that adjust an airflow passing through the mesh belt. By displacing the wind direction plates, it is possible to adjust a basis weight (distribution of basis weight) of the sheet as desired.

However, in the configuration described in JP-A-2019-143256, an installation position of the wind direction plates is limited, and the range of adjustment of the basis weight (distribution of basis weight) of the sheet is limited. For this reason, there is a possibility that the adjustment of the basis weight (distribution of the basis weight) of the sheet cannot be favorably performed.

### SUMMARY

An accumulation device of the present disclosure includes: a supply pipe for supplying a material containing fibers; a chamber for dispersing the material supplied from the supply pipe in air; an accumulating member provided vertically below the chamber for accumulating the material dispersed in the air to generate an accumulated material; and a suction section for sucking the air from vertically below the accumulating member through the accumulating member. The chamber has a supply port to which the supply pipe is coupled, an outside air intake port provided at a position different from the supply port for taking in outside air, and at least one wind direction plate for changing a flow of the outside air taken in from the outside air intake port.

A method for producing a fiber body according to the present disclosure includes: a supply step of supplying a material containing fibers into a chamber; an accumulation step of accumulating the material on the accumulating member to generate an accumulated material by sucking while dispersing the material in the air in the chamber; and a production step of producing a fiber body by forming the accumulated material. In the accumulation step, the outside air is taken in from the outside air intake port provided in the chamber, and the flow of the air in the chamber is adjusted by changing a flow of the outside air taken in from the outside air intake port, and a thickness distribution of the accumulated material on the accumulating member is adjusted.

### BRIEF DESCRIPTION OF THE DRAWINGS

FIG. 1 is a configuration diagram schematically showing a fiber body manufacturing apparatus including an accumulation device according to a first embodiment of the present disclosure.

FIG. 2 is a partial cross-sectional view of the accumulation device shown in FIG. 1.

FIG. 3 is a partial cross-sectional view of the accumulation device shown in FIG. 1.

FIG. 4 is an enlarged view of wind direction plates included in the accumulation device shown in FIG. 1.

FIG. 5 is an enlarged view of a wind direction plate included in the accumulation device according to a second embodiment of the present disclosure.

FIG. 6 is a block diagram of the accumulation device according to the second embodiment of the present disclosure.

FIG. 7 is a view for explaining variations of inclination angles of the wind direction plates included in the accumulation device shown in FIG. 1.

FIG. 8 is a view for explaining variations of inclination angles of the wind direction plates included in the accumulation device shown in FIG. 1.

FIG. 9 is a graph showing distribution of basis weight of accumulated materials for each inclination angle of the wind direction plates shown in FIG. 7.

FIG. 10 is a graph showing distribution of basis weight of accumulated materials for each inclination angle of the wind direction plates shown in FIG. 8.

### DESCRIPTION OF EMBODIMENTS

Hereinafter, an accumulation device and a method for producing a fiber body according to the present disclosure will be described in detail based on preferred embodiments shown in the accompanying drawings.

### First Embodiment

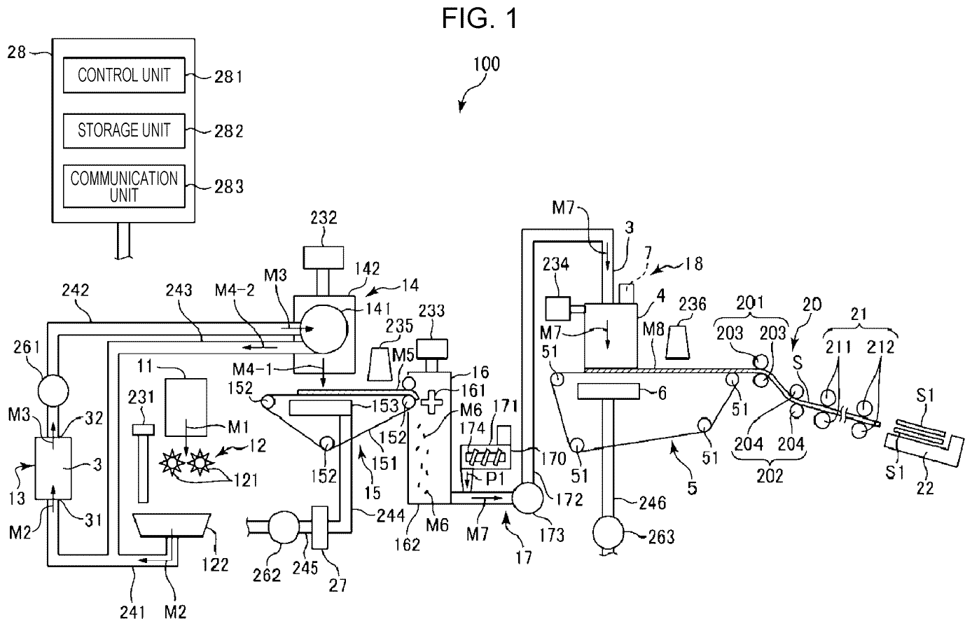

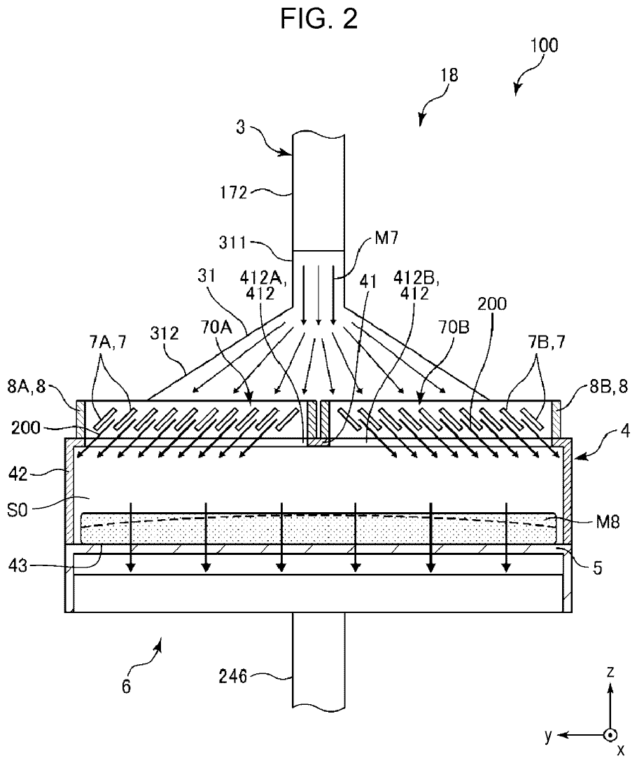

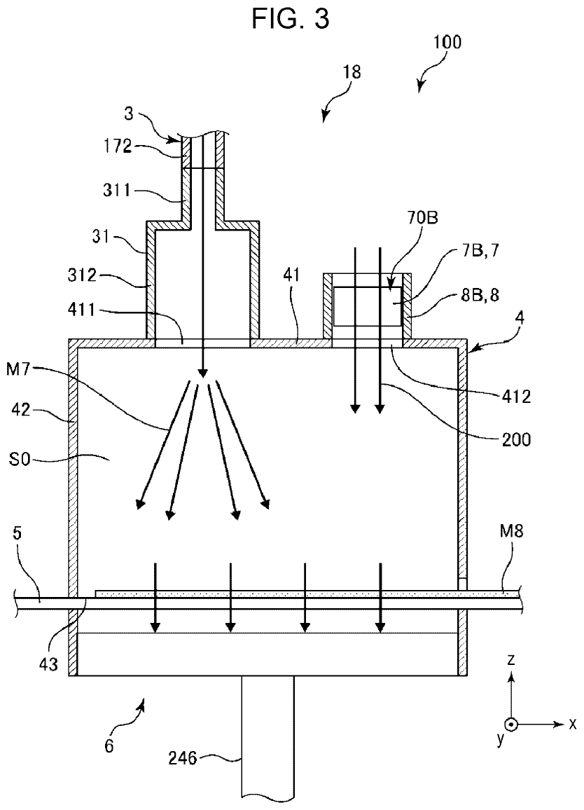

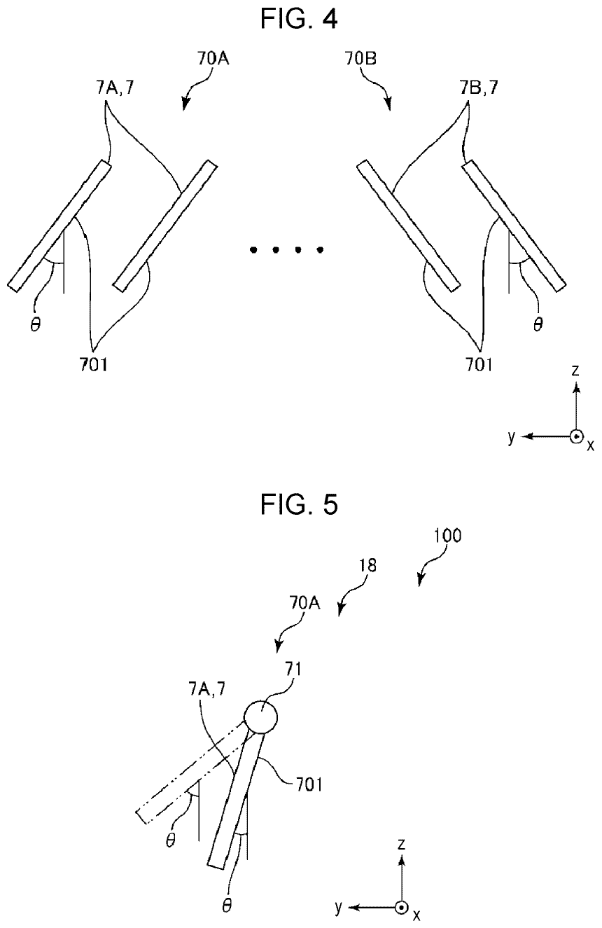

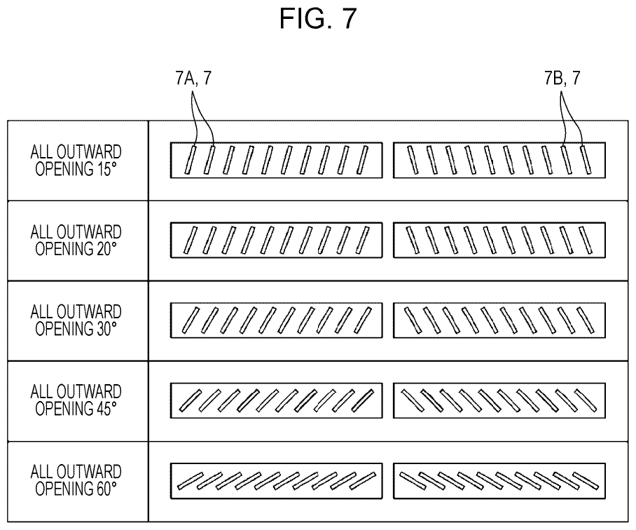

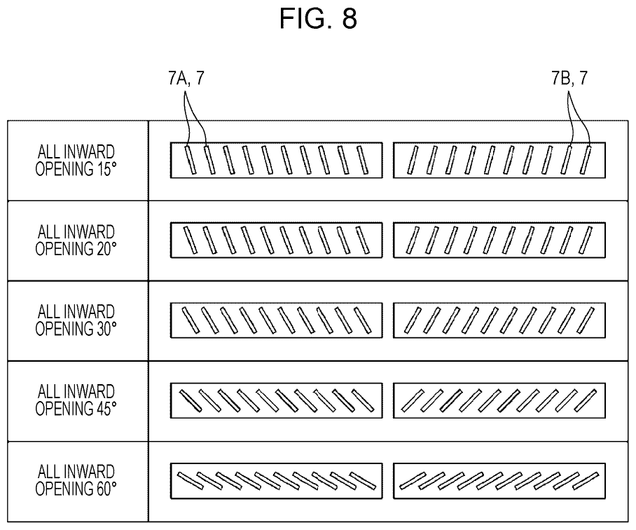

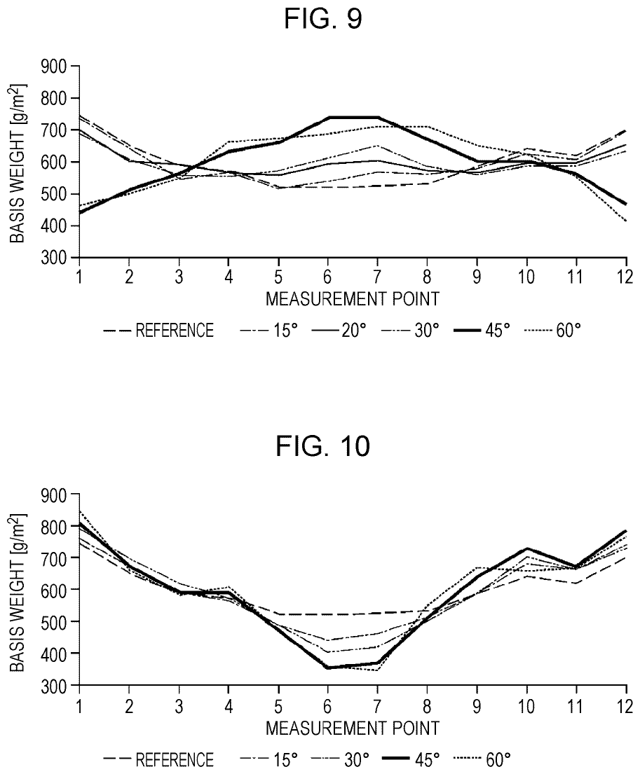

FIG. 1 is a configuration diagram schematically showing a fiber body manufacturing apparatus including an accumulation device according to the first embodiment of the present disclosure. FIG. 2 is a partial cross-sectional view of the accumulation device shown in FIG. 1. FIG. 3 is a partial cross-sectional view of the accumulation device shown in FIG. 1. FIG. 4 is an enlarged view of the wind direction plates included in the accumulation device shown in FIG. 1. FIGS. 7 and 8 are views for explaining variations of inclination angles of the wind direction plates included in the accumulation device shown in FIG. 1. FIG. 9 is a graph showing distribution of basis weight of accumulated materials for each inclination angle of the wind direction plates shown in FIG. 7. FIG. 10 is a graph showing distribution of basis weight of accumulated materials for each inclination angle of the wind direction plates shown in FIG. 8. FIGS. 2 and 3 are partial cross-sectional views of the same accumulation device as viewed from different directions, but a scale of FIG. 2 is partially different for ease of explanation, and each view is not drawn to the same scale.

Hereinafter, in FIGS. 1 and 2, the upper side may be referred to as “upper” or “above”, and the lower side may be referred to as “lower” or “below”. In FIG. 2, the left side may be referred to as “left” or “left side”, and the right side may be referred to as “right” or “right side”. In addition, FIG. 1 is a schematic configuration diagram, and a positional relationship, orientation, size, and the like of each section of a fiber body manufacturing apparatus 100 are not limited to those shown in the drawing. In FIG. 1, a direction in which a crushed piece M2, a defibrated material M3, a first sorted material M4-1, a second sorted material M4-2, a first web M5, a subdivided body M6, a mixture M7, a second web M8, and a sheet S1 are transported, that is, directions indicated by arrows are also referred to as a transport direction. Further, the tip end side of the arrows in FIG. 1 is also referred to as “downstream” in the transport direction, and the base end side of the arrows in FIG. 1 is also referred to as “upstream” in the transport direction.

In addition, in FIGS. 2, 3, and 4 (the same applies to FIG. 5), an x-axis, a y-axis, and a z-axis are shown as three axes orthogonal to each other, and a side indicated by an arrow (tip end side) of each axis will be described as a + side and an opposite side thereof will be described as a − side. The x-axis and the y-axis are axes along a horizontal direction, and the z-axis is an axis along a vertical direction.

The fiber body manufacturing apparatus 100 shown in FIG. 1 generates sheet S1 that is an example of a fiber body, from raw material M1 that is used paper such as used copy paper. The fiber body manufactured by the fiber body manufacturing apparatus 100 is not limited to the sheet S1, and may be a plate-shaped member or a block-shaped member. Furthermore, a product such as a bag processed from the sheet S1 or the like is also included in the fiber body.

As shown in FIG. 1, the fiber body manufacturing apparatus 100 includes a raw material supply section 11, a crushing section 12, a defibrating section 13, a sorting section 14, a first web generating section 15, a subdivision section 16, a mixing section 17, an accumulation device 18, a forming section 20, a cutting section 21, a stock section 22, and a collection section 27.

The fiber body manufacturing apparatus 100 also includes a humidification section 231, a humidification section 232, a humidification section 233, a humidification section 234, a humidification section 235, and a humidification section 236. In addition, the fiber body manufacturing apparatus 100 includes a blower 173, a blower 261, a blower 262, and a blower 263.

Further, in the fiber body manufacturing apparatus 100, a raw material supply step, a crushing step, a defibrating step, a sorting step, a first web generating step, a division step, a mixing step, a supply step, an accumulation step, a forming step, and a cutting step are executed in this order.

Each section of the fiber body manufacturing apparatus 100 is electrically coupled to a control device 28. The operation of each of these sections is controlled by the control device 28.

As illustrated in FIG. 1, the control device 28 includes a control unit 281, a storage unit 282, and a communication unit 283.

The control unit 281 has at least one processor and executes various programs stored in the storage unit 282. As a processor, for example, a central processing unit (CPU) or an application-specific integrated circuit (ASIC) can be used. In addition, the control unit 281 has various functions such as a function of controlling driving of each portion of the apparatus related to sheet manufacturing.

The storage unit 282 stores, for example, a program related to sheet manufacturing, a program related to rotational drive of a wind direction plate 7, or the like, as described in the second embodiment.

The communication unit 283 is configured with, for example, an I/O interface, and communicates with each section of the fiber body manufacturing apparatus 100. Further, the communication unit 283 has a function of communicating with, for example, a computer or a server (not shown) via a network.

The control device 28 may be built in the fiber body manufacturing apparatus 100, or may be provided in an external device such as an external computer. Further, for example, the control unit 281 and the storage unit 282 may be integrated and configured as one unit, or the control unit 281 may be built in the fiber body manufacturing apparatus 100 and the storage unit 282 may be provided in an external device such as an external computer, or the storage unit 282 may be built in the fiber body manufacturing apparatus 100 and the control unit 281 may be provided in an external device such as an external computer.

Hereinafter, a configuration of each section will be described.

The raw material supply section 11 is a section that performs the raw material supply step of supplying the raw material M1 to the crushing section 12. The raw material M1 is, for example, a sheet-like material made of a fiber-containing material containing cellulose fibers. The raw material M1 may be a fiber-containing material containing any fibers such as chemical fibers, and a shape of the raw material is not limited to a sheet shape and may be any shape such as a clump shape.

The crushing section 12 is a section that performs, in the air such as in the atmosphere, the crushing step of crushing the raw material M1 supplied from the raw material supply section 11. The crushing section 12 includes a pair of crushing blades 121 and a chute 122.

By rotating the pair of crushing blades 121 in opposite directions to each other, the raw material M1 can be crushed therebetween, that is, cut into the crushed piece M2. It is preferable that a shape and a size of the crushed piece M2 be suitable for a defibrating process in the defibrating section 13. Examples of the shape of the crushed piece M2 include a small piece having a square planar shape and a rectangular shape, particularly a strip-shaped small piece. Regarding a size, the crushed piece M2 is preferably a small piece, for example, with an average side length of 100 mm or less, and more preferably, with an average side length of 3 mm or more and 70 mm or less. The shape of the small piece may be other than a square shape or a rectangular shape. In addition, it is preferable that the thickness be 0.07 mm or more and 0.10 mm or less.

The chute 122 is disposed below the pair of crushing blades 121 and has, for example, a conical shape or a funnel shape. As a result, the chute 122 can receive the crushed piece M2 that was crushed by the crushing blades 121 and fell.

Further, above the chute 122, a humidification section 231 is disposed adjacent to the pair of crushing blades 121. The humidification section 231 humidifies the crushed piece M2 in the chute 122. The humidification section 231 has a filter (not shown) containing moisture, and is configured by an evaporative humidifier that supplies humidified air with increased moisture to the crushed piece M2 by passing air through the filter. By supplying the humidified air to the crushed piece M2, it is possible to suppress the crushed piece M2 from adhering to the chute 122 or the like due to electrostatic force.

The chute 122 is coupled to the defibrating section 13. The crushed piece M2 collected by the chute 122 are supplied to the defibrating section 13. The defibrating section 13 is a section that performs the defibrating step of defibrating the crushed piece M2 in air, that is, in a dry process. The defibrating process in the defibrating section 13 can generate a defibrated material M3 from the crushed piece M2. Here, “defibrating” means untangling the crushed piece M2 formed by binding a plurality of fibers into individual fibers. Then, the untangled material becomes the defibrated material M3. The shape of the defibrated material M3 is linear or band-like. In addition, the defibrated material M3 may exist in a state in which the defibrated materials M3 are entangled with each other in a clump shape, that is, a state in which a so-called “lump” is formed.

The defibrating section 13 can generate a flow of air, that is, an airflow, toward the sorting section 14 by the rotation of a rotor (not shown). As a result, the crushed piece M2 can be introduced to the upstream of the defibrating section 13 from a pipe 241, and after the defibrating process, the defibrated material M3 can be delivered to the sorting section 14 through a pipe 242.

The pipe 242 is coupled downstream of the defibrating section 13. In the middle of the pipe 242, the blower 261 configured with, for example, a turbo type fan is installed. The blower 261 is an airflow generation device that generates an airflow toward the sorting section 14. As a result, introduction of the crushed piece M2 to the defibrating section 13 and delivery of the defibrated material M3 to the sorting section 14 are promoted. Due to the structure of the defibrating section 13, the passage and defibrating process of the crushed piece M2, which is a raw material, are smoothly performed, and by the operation of the blower 261 installed downstream of the defibrating section 13, the passage and defibrating process of the crushed piece M2 in the defibrating section 13 are promoted. The blower 261 may be installed upstream of the defibrating section 13.

The sorting section 14 is a section that performs the sorting step of sorting fibers to be used in a subsequent step from the defibrated material M3. In the sorting section 14, the defibrated material M3 is sorted into a first sorted material M4-1 and a second sorted material M4-2 having a fiber length larger than that of the first sorted material M4-1. The first sorted material M4-1 has a size suitable for the sheet S1 in the subsequent step and has a size suitable for a manufacturing of the sheet S1 in the subsequent step. On the other hand, the second sorted material M4-2 includes, for example, those with insufficient defibration, those in which the defibrated fibers are excessively aggregated, and the like.

The sorting section 14 has a drum section 141 and a housing section 142 that houses the drum section 141.

The drum section 141 is formed of a cylindrical net body, and is a sieve that rotates around a central axis thereof. The defibrated material M3 flows into the drum section 141. By a rotation of the drum section 141, the defibrated material M3 smaller than a mesh opening of a net is sorted as the first sorted material M4-1, and the defibrated material M3 having a size equal to or larger than the mesh opening of the net is sorted as the second sorted material M4-2.

The first sorted material M4-1 falls from the drum section 141.

On the other hand, the second sorted material M4-2 is delivered to a pipe 243 coupled to the drum section 141. An end portion of the pipe 243 on the side opposite to the drum section 141, that is, on the downstream, is coupled to the middle of the pipe 241. The second sorted material M4-2 that has passed through the pipe 243 joins the crushed piece M2 in the pipe 241 and flows into the defibrating section 13 together with the crushed piece M2. As a result, the second sorted material M4-2 is returned to the defibrating section 13 and processed for defibration together with the crushed piece M2.

Also, the first sorted material M4-1 that has fallen from the drum section 141 falls while dispersing in the air, and heads toward a first web generating section 15 positioned below the drum section 141. The first web generating section 15 is a section that performs the first web generating step of generating the first web M5 from the first sorted material M4-1. The first web generating section 15 includes a mesh belt 151, three tension rollers 152, and a suction section 153.

The mesh belt 151 is an endless belt on which the first sorted material M4-1 is accumulated. The mesh belt 151 is hung around the three tension rollers 152. Then, the first sorted material M4-1 on the mesh belt 151 is transported to the downstream by the rotational drive of the tension rollers 152.

The first sorted material M4-1 has a size equal to or larger than the mesh opening of the mesh belt 151. As a result, the passage of the first sorted material M4-1 through the mesh belt 151 is restricted, and accordingly, the first sorted material M4-1 can be accumulated on the mesh belt 151. Since the first sorted material M4-1 is transported to the downstream together with the mesh belt 151 while accumulating on the mesh belt 151, the first sorted material M4-1 is generated as a layered first web M5.

In addition, for example, there is a concern that dust, dirt, or the like will be mixed into the first sorted material M4-1. Dust or dirt may be generated by, for example, crushing or defibrating. Then, such dust or dirt will be collected by a collection section 27 which will be described later.

The suction section 153 is a suction mechanism that sucks air from below the mesh belt 151. As a result, dust or dirt that passed through the mesh belt 151 can be suctioned together with the air.

Further, the suction section 153 is coupled to the collection section 27 via a pipe 244. The dust or dirt suctioned by the suction section 153 is collected by the collection section 27.

A pipe 245 is further coupled to the collection section 27. In addition, the blower 262 is installed in the middle of the pipe 245. By the operation of the blower 262, a suction force can be generated in the suction section 153. This promotes generation of the first web M5 on the mesh belt 151. Dust, dirt, or the like is removed from the first web M5. Further, the dust or dirt passes through the pipe 244 and reach the collection section 27 by the operation of the blower 262.

The housing section 142 is coupled to the humidification section 232. The humidification section 232 is configured by an evaporative humidifier. As a result, humidified air is supplied into the housing section 142. The first sorted material M4-1 can be humidified by the humidified air, and thus adhesion of the first sorted material M4-1 to the inner wall of the housing section 142 due to the electrostatic force can be suppressed.

The humidification section 235 is disposed on the downstream of the sorting section 14. As a result, moisture can be supplied to the first web M5, and thus a water content of the first web M5 is adjusted. By this adjustment, adsorption of the first web M5 to the mesh belt 151 due to the electrostatic force can be suppressed. As a result, the first web M5 is easily peeled off from the mesh belt 151 at the position where the mesh belt 151 is folded back by one of the tension rollers 152.

The subdivision section 16 is disposed on the downstream of the humidification section 235. The subdivision section 16 is a section that performs the division step of dividing the first web M5 peeled off from the mesh belt 151. The subdivision section 16 has a propeller 161 rotatably supported and a housing section 162 that stores the propeller 161. Then, the first web M5 can be divided by the rotating propeller 161. The divided first web M5 becomes a subdivided body M6. Further, the subdivided body M6 descends in the housing section 162.

The housing section 162 is coupled to the humidification section 233. The humidification section 233 is configured by an evaporative humidifier. As a result, humidified air is supplied into the housing section 162. The humidified air can also suppress adhesion of the subdivided body M6 to the inner wall of the propeller 161 or the housing section 162 due to the electrostatic force.

The mixing section 17 is disposed on the downstream of the subdivision section 16. The mixing section 17 is a section that performs the mixing step of mixing the subdivided body M6 and an additive. The mixing section 17 includes an additive supply section 171, a pipe 172, and the blower 173. The pipe 172 is a flow path which couples the housing section 162 of the subdivision section 16 with a chamber 4 of the accumulation device 18, and through which the mixture M7 of the subdivided body M6 and the additive passes.

The additive supply section 171 is coupled to the middle of the pipe 172. The additive supply section 171 has a housing section 170 in which the additive is housed, and a screw feeder 174 provided in the housing section 170. By a rotation of the screw feeder 174, the additive in the housing section 170 is pushed out from the housing section 170 and supplied into the pipe 172. The additive supplied into the pipe 172 is mixed with the subdivided body M6 to form the mixture M7.

Examples of the additives supplied from the additive supply section 171 include a binder for binding fibers to each other, a coloring agent for coloring fibers, an aggregation inhibitor for suppressing fiber aggregation, a flame retardant for making fibers and the like unlikely to burn, and a paper strength enhancing agent for enhancing a paper strength of the sheet S1, and these mentioned above can be used alone, or a plurality of additives among these can be used in combination. Hereinafter, as an example, a case where the additive is a binder P1 will be described. The additive includes a binder that binds fibers to each other, and accordingly, the strength of the sheet S1 can be increased.

Examples of the binder P1 include: thermoplastic resins such as various polyolefins, acrylic resins, polyvinyl chloride, polyesters, and polyamides; various thermoplastic elastomers; and natural product-derived ingredients such as starch, dextrin, glycogen, amylose, hyaluronic acid, arrowroot, konjac, potato starch, etherified starch, esterified starch, natural gum glue, fiber-derived glue, seaweed, and animal protein, and one or two or more selected from these can be used in combination.

In the middle of the pipe 172, the blower 173 is installed on the downstream of the additive supply section 171. The action of the rotating section such as a blade of the blower 173 promotes mixing of the subdivided body M6 and the binder P1. The blower 173 can also generate an airflow toward the accumulation device 18. The subdivided body M6 and the binder P1 can be stirred in the pipe 172 by the airflow. As a result, the mixture M7 is transported to the accumulation device 18 in a state where the subdivided body M6 and the binder P1 are uniformly dispersed. Further, the subdivided body M6 in the mixture M7 is loosened in the process of passing through the pipe 172 to become a finer fibrous form.

Note that the blower 173 is electrically coupled to the control device 28, and the operation thereof is controlled. Further, by adjusting an air blowing volume of the blower 173, the amount of air sent into the accumulation device 18 can be adjusted.

The accumulation device 18 shown in FIG. 1 is a section that executes a second web generating step of dispersing and accumulating the mixture M7 in the air to generate a second web M8 as an accumulated material. The configuration of the accumulation device 18 will be described in detail later. The second web M8 generated by the accumulation device 18 is transported and supplied to the forming section 20.

A forming section 20 is disposed on the downstream (right side) of the accumulation device 18. The forming section 20 is a section that performs the forming step of generating the sheet S1 from the second web M8. The forming section 20 includes a pressurization section 201, a heating section 202, and a cutting section 21.

The pressurization section 201 has a pair of calender rollers 203, and can pressurize the second web M8 between the calender rollers 203 without heating. Thereby, the density of the second web M8 is increased. The degree of heating in a case of heating is, for example, preferably a degree that the binder P1 is not melted. Then, the second web M8 is transported toward the heating section 202. One of the pair of calender rollers 203 is a drive roller driven by the operation of a motor (not shown), and the other is a driven roller.

The heating section 202 has a pair of heating rollers 204 on the downstream of the pressurization section 201, and can pressurize the second web M8 while heating the second web M8 between the heating rollers 204. By this heating and pressurization, the binder P1 is melted in the second web M8, and the fibers are bonded to each other via the melted binder P1. As a result, the sheet S1 is generated. Then, the sheet S1 is transported toward the cutting section 21. Note that one of the pair of heating rollers 204 is a drive roller driven by the operation of a motor (not shown), and the other is a driven roller.

The cutting section 21 is disposed on the downstream (right side) of the heating section 202. The cutting section 21 is a section that performs the cutting step of cutting the sheet S1. The cutting section 21 has a first cutter 211 and a second cutter 212. The first cutter 211 cuts the sheet S1 in a direction intersecting with a transport direction of the sheet S1, particularly in a direction orthogonal to the transport direction. The second cutter 212 cuts the sheet S1 in a direction parallel to the transport direction of the sheet S1 on the downstream of the first cutter 211. This cutting is for removing unnecessary portions of both side end portions of the sheet S1 in a widthwise direction to adjust the width of the sheet S1.

Through such cutting with the first cutter 211 and the second cutter 212, the sheet S1 having a desired shape and size is obtained. The stock section 22 is disposed on the downstream (right side) of the cutting section 21. The sheet S1 obtained through the cutting section 21 is transported further downstream, sent to the stock section 22, and stored in the stock section 22. The stock section 22 is a section that temporarily stores the sheet S1 in a state where the sheets are stacked in a thicknesswise direction thereof. The number of sheets stored in the stock section 22 is not particularly limited, but may be, for example, from five sheets or more to about 100 sheets.

Next, a configuration of the accumulation device 18 will be described.

As shown in FIGS. 2 and 3, the accumulation device 18 includes a supply pipe 3, a chamber 4, a mesh belt 5 as an accumulating member, a suction section 6, and wind direction plates 7. The supply pipe 3 is a section that executes the supply step, and the chamber 4, the mesh belt 5, the suction section 6, and the wind direction plates 7 are sections that execute the accumulation step.

The supply pipe 3 supplies the mixture M7, which is a material containing fibers, to the chamber 4 (supply step). The supply pipe 3 includes the pipe 172 described above and a supply port 31. The pipe 172 may be a constituent element of the supply pipe 3 or need not be a component element of the supply pipe 3. The end portion on the downstream of the pipe 172 has a portion extending along the z-axis direction, and supplies the mixture M7 from the +z-axis side.

The supply port 31 is coupled to the end portion on the downstream of the pipe 172 and includes a first portion 311 coupled to the pipe 172 and a second portion 312 coupled to the −z-axis side of the first portion 311. Note that the first portion 311 may be omitted, or may have a bent portion.

As shown in FIG. 3, the second portion 312 has an inner cavity portion, and is a portion whose inner diameter and outer diameter increase toward the −z-axis side. That is, a cross-sectional area of the inner cavity portion of the second portion 312 increases toward the −z-axis side. The second portion 312 has a constant width of the inner cavity portion in the x-axis direction regardless of the position in the z-axis direction, and the length of the inner cavity portion in the y-axis direction increases toward the −z-axis side. According to such a configuration, the mixture M7 that has flowed down to the second portion 312 spreads toward the +y-axis side and the −y-axis side as the mixture M7 goes toward the −z-axis side. Thus, the mixture M7 can be accumulated over a wide range in the widthwise direction (y-axis direction) of the mesh belt 5. Therefore, as described later, the second web M8 having a desired thickness distribution can be easily obtained.

The chamber 4 disperses the mixture M7 supplied from the supply pipe 3 in the air. The chamber 4 includes a top plate 41 and four side walls 42 vertically provided on the −z-axis side from an edge portion of the top plate 41. The top plate 41 is installed in a direction in which the z-axis direction is the thickness direction. The top plate 41 has a supply port 411 to which the supply port 31 is coupled, and an outside air intake port 412 for taking in outside air 200. The supply port 411 has an elongated shape extending in the y-axis direction and has a shape corresponding to a shape of the lower end portion of the supply port 31. Two outside air intake ports 412 are provided, each of which has an elongated shape extending in the y-axis direction. Each of the outside air intake ports 412 is provided at a position separated from the supply port 411 on the +x-axis side (on the downstream in the transport direction of the second web M8). Each of the outside air intake ports 412 are provided so as to be separated from each other in the y-axis direction. Since the outside air intake ports 412 have a shape extending in the y-axis direction, the outside air 200 can be taken in over a wide range in the y-axis direction. The outside air is the air outside the chamber 4, and may be the air outside the fiber body manufacturing apparatus 100 or the air inside the fiber body manufacturing apparatus 100.

Edge portions of the four side walls 42 on the −z-axis side form an opening 43. While the mixture M7 supplied from the supply pipe 3 is floating in the chamber 4, that is, an internal space S0 surrounded by the top plate 41 and the four side walls 42, entangled fibers are loosened, fallen, and discharged from the opening 43 and accumulated on the mesh belt 5.

As shown in FIG. 1, the humidification section 234 is coupled to the chamber 4. Thus, the humidified air is supplied into the chamber 4. The inside of the chamber 4 can be humidified by the humidified air, and thus adhesion of the mixture M7 to the inner surfaces of the top plate 41 and the side walls 42 due to the electrostatic force can be suppressed.

The mesh belt 5 is provided vertically below the chamber 4 (−z-axis side), and transports the second web M8 in the +x-axis direction (a first direction intersecting the vertical direction) while generating the second web M8 as an accumulated material by accumulating the mixture M7 dispersed in the air. As shown in FIG. 1, the mesh belt 5 is formed of an endless belt and is hung around four tension rollers 51. Then, the mixture M7 on the mesh belt 5 is transported to the downstream by a rotational drive of the tension rollers 51.

In the configuration shown in the drawings, the mesh belt 5 is used as an example of the accumulating member, but the present disclosure is not limited thereto, and for example, a flat plate shape may be used.

In addition, most of the mixtures M7 on the mesh belt 5 have a size equal to or larger than the mesh opening of the mesh belt 5. As a result, the passage of the mixture M7 through the mesh belt 5 is restricted, and thus, the mixture M7 can accumulate on the mesh belt 5. Since the mixture M7 is transported to the downstream along with the mesh belt 5 while accumulating on the mesh belt 5, the mixture M7 is generated as a layered second web M8.

The suction section 6 is a suction mechanism that sucks, from vertically below the mesh belt 5, through the mesh belt 5, the mixture M7 supplied from the supply pipe 3 and the outside air 200 taken in from the outside air intake port 412. As a result, the mixture M7 can be sucked onto the mesh belt 5, and thus the accumulation of the mixture M7 on the mesh belt 5 is promoted.

As shown in FIG. 1, a pipe 246 is coupled to the suction section 6. In addition, the blower 263 is installed in the middle of the pipe 246. By the operation of the blower 263, a suction force can be generated in the suction section 6. Since the flow rate of the air sucked by the suction section 6 is larger than the flow rate of the air supplied from the supply pipe 3 together with the mixture M7, the balance of these flow rates is improved by taking in the air from the outside air intake port 412, and a stable airflow can be formed in the chamber 4. Therefore, the thickness of the second web M8 can have a desired thickness distribution.

As shown in FIG. 1, the humidification section 236 is disposed on the downstream side (right side) of the chamber 4. As a result, moisture can be supplied to the second web M8, and thus a water content of the second web M8 is adjusted. By this adjustment, adsorption of the second web M8 to the mesh belt 5 due to the electrostatic force can be suppressed. As a result, the second web M8 is easily peeled off from the mesh belt 5 at the position where the mesh belt 5 is folded back by one of the tension rollers 51.

The total water content added to the humidification sections 231 to 236 is preferably, for example, 0.5 parts by mass or more and 20 parts by mass or less with respect to 100 parts by mass of the material before humidification.

Here, as shown in FIG. 2, the top plate 41 includes the supply port 411, the outside air intake port 412 which is provided at a position different from the supply port 411 and takes in the outside air 200, a plurality of wind direction plates 7 which straightens (changes) the outside air 200 taken in from the outside air intake port, and a support member 8 which supports each wind direction plate 7. Here, straightening the outside air 200 taken in from the outside air intake port means, for example, changing a direction of the airflow in a desired direction. In the following description, of the two outside air intake ports 412, the outside air intake port 412 on the +y-axis side is referred to as an “outside air intake port 412A”, and the outside air intake port 412 on the −y-axis side is referred to as an “outside air intake port 412B”. Each of the wind direction plates 7 installed in the outside air intake port 412A is referred to as “wind direction plate 7A”, and the support member 8 supporting the wind direction plates 7A is referred to as “support member 8A”. Each of the wind direction plate 7 installed in the outside air intake port 412B is referred to as “wind direction plate 7B”, and the support member 8 supporting the wind direction plates 7B is referred to as “support member 8B”. Further, a plurality of wind direction plates 7A is referred to as a first wind direction plate group 70A, and a plurality of wind direction plates 7B is referred to as a second wind direction plate group 70B. By providing the plurality of wind direction plates 7A and the plurality of wind direction plates 7B, the outside air 200 can be straightened over a wide range in the widthwise direction (y-axis direction) of the mesh belt 5. Therefore, as described later, the second web M8 having a desired accumulation distribution can be easily obtained. In the present embodiment, each of the wind direction plates is a rectangular flat plate. However, the shape of the wind direction plates is not limited thereto. For example, a corrugated shape or an elliptical flat plate may be used. In addition, the plurality of wind direction plates may all have the same shape, or may include wind direction plates having different shapes.

It can be said that the outside air intake port 412A and the outside air intake port 412B are provided on the sides opposite to each other with respect to the center of the chamber 4 in the y-axis direction. It can be said that the wind direction plates 7A and the wind direction plates 7B are provided on the sides opposite to each other with respect to the center of the chamber 4 in the y-axis direction.

The wind direction plates 7A straighten air that flows in from the outside air intake port 412A. Specifically, each of the wind direction plates 7A is inclined such that an end portion on the −z-axis side is positioned closer to the +y-axis side than an end portion on the +z-axis side. Therefore, the direction of the outside air 200 flowing in from the +z-axis side is changed so as to be directed to the −z-axis side and the +y-axis side. In the configuration shown in the drawings, each of the wind direction plates 7A is installed so as to be parallel to each other. However, the present disclosure is not limited to this configuration, and the wind direction plates 7A need not be parallel to each other.

The wind direction plates 7B straighten air that flows in from the outside air intake port 412B. Specifically, each of the wind direction plate 7B is inclined such that an end portion on the −z-axis side is positioned closer to the −y-axis side than an end portion on the +z-axis side. Therefore, the direction of the outside air 200 flowing in from the +z-axis side is changed so as to be directed to the −z-axis side and the −y-axis side. In the configuration shown in the drawings, each of the wind direction plates 7B is installed so as to be parallel to each other. However, the present disclosure is not limited to this configuration, and the wind direction plates 7B need not be parallel to each other.

In this way, the wind direction plate 7A and the wind direction plate 7B are installed so as to open outward. However, the present disclosure is not limited to this configuration, and the wind direction plate 7A and the wind direction plate 7B may be installed so as to open inward. Inward opening refers to a state in which each of the wind direction plates 7A is inclined such that the end portion on the −z-axis side is positioned closer to the −y-axis side than the end portion on the +z-axis side, and each of the wind direction plates 7B is inclined such that the end portion on the −z-axis side is positioned closer to the +y-axis side than the end portion on the +z-axis side. An example of a variation of outward opening is as shown in FIG. 7. An example of a variation of inward opening is as shown in FIG. 8. Further, the wind direction plates 7A and the wind direction plates 7B may be installed in a state where installations of outward opening and inward opening are mixed.

The support member 8A and the support member 8B are each formed of a cylindrical member that is open to the +z-axis side and the −z-axis side. The support member 8A supports an end portion on the +x-axis side and an end portion on the −x-axis side of each of the wind direction plates 7A on the inside thereof. The support member 8B supports an end portion on the +x-axis side and an end portion on the −x-axis side of each of the wind direction plates 7B on the inside thereof. Each of the wind direction plates 7A and each of the wind direction plates 7B are arranged at equal intervals, but the present disclosure is not limited to this configuration, and the wind direction plates 7A and the wind direction plates 7B need not be arranged at equal intervals.

In this way, the outside air 200 straightened by the wind direction plates 7A and the wind direction plates 7B flows into the chamber 4, and accordingly, the flow of the air in the chamber 4 can be adjusted. Therefore, the mixture M7 supplied from the supply pipe 3 into the chamber 4 can be accumulated at a desired position of the mesh belt 5 (accumulation step). As a result, the thickness of the second web M8 can be adjusted so that the second web M8 has a desired thickness distribution. More specifically, when the outside air 200 that is straightened by the wind direction plates 7A and the wind direction plates 7B flows into the chamber 4, sparsity and density of the air in the chamber 4 are generated. The air is drawn from the mesh belt 5, and the mixture M7 is easily accumulated in a portion where the air becomes sparse. For example, when the wind direction plates 7A and the wind direction plates 7B are directed to the outward sides in the y-axis direction, the air in the chamber 4 becomes sparse on the center side in the y-axis direction and becomes dense on the outward sides in the y-axis direction. As a result, a large amount of the mixture M7 is accumulated in the central portion in the y-axis direction where the air is sparse. By using the wind direction plates 7A and the wind direction plates 7B in this way, sparsity and density of the air in the chamber 4 can be adjusted, and the mixture M7 can be accumulated more thickly in the central portion in the y-axis direction than on the outward sides, or conversely, the mixture M7 can be accumulated more thickly on the outward sides in the y-axis direction than in the central portion in the y-axis direction, or conversely, the mixture M7 can be accumulated more thickly at one end in the y-axis direction than the other end in the y-axis direction.

In either of the inward opening or the outward opening, as shown in FIG. 4, the inclination angle θ of each wind direction plate 7 with respect to the vertical direction (an angle formed by a surface 701 of the wind direction plate 7 facing the −z-axis side and the vertical direction) is preferably more than 0° and less than 45°, and more preferably 15° or more and 35° or less. By setting the inclination angle θ within such a numerical range, it is possible to obtain the second web M8 having a thickness distribution of which needs are generally high.

In particular, when the inclination angle θ is more than 0° and less than 45°, following advantages are obtained. FIGS. 9 and 10 show a basis weight distribution of the second web M8 for each inclination angle θ, with the vertical axis indicating the basis weight [g/m²] and the horizontal axis indicating the position of the second web M8 (measurement points 1 to 12) in the widthwise direction. FIG. 9 corresponds to the outward opening shown in FIG. 7, and FIG. 10 corresponds to the inward opening shown in FIG. 8. When the inclination angle θ is more than 0° and less than 45°, as compared with a case described as a reference without wind direction plates, the basis weight [g/m²] is more likely to be symmetrical with respect to the center in the widthwise direction and is less likely to sharply change at measurement points adjacent to each other in the widthwise direction. Therefore, when the inclination angle θ is more than 0° and less than 45°, the second web M8 having higher quality can be obtained.

As described above, the accumulation device 18 includes the supply pipe 3 for supplying the mixture M7 that is a material containing fibers, the chamber 4 for dispersing the mixture M7 supplied from the supply pipe 3 in the air, the mesh belt 5 that is the accumulating member provided vertically below the chamber 4 for accumulating the mixture M7 dispersed in the air to generate the second web M8 that is the accumulated material, and the suction section 6 for sucking the air from vertically below the mesh belt 5 through the mesh belt 5. The chamber 4 has the supply port 411 to which the supply pipe 3 is coupled, the outside air intake port 412 provided at a position different from the supply port 411 to take in the outside air 200, and at least one wind direction plate 7 to change the flow of the outside air 200 taken in from the outside air intake port 412. Thus, the second web M8 having a desired thickness distribution can be obtained. In the configuration shown in the drawings, 20 wind direction plates 7 are provided, but the present disclosure is not limited thereto, and 1 to 19 or 21 or more wind direction plates 7 may be provided.

Further, the method for producing a fiber body includes: the supply step of supplying the mixture M7 as a material containing fibers into the chamber 4; the accumulation step of accumulating the mixture M7 on the mesh belt 5 as the accumulating member to generate the second web M8 that is the accumulated material by sucking while dispersing the mixture M7 in the air in the chamber 4; and the production step of producing a fiber body by forming the second web M8. In the accumulation step, the outside air 200 is taken in from the outside air intake port 412 provided in the chamber 4, and the flow of the air in the chamber 4 is adjusted by changing the flow of the outside air taken in from the outside air intake port 412, and a thickness distribution of the second web M8 on the mesh belt 5 is adjusted. Thus, the second web M8 having a desired thickness distribution can be obtained.

In addition, the fiber body manufacturing apparatus 100 includes the defibrating section 13 that defibrates the crushed pieces M2 as a fiber material to generate the defibrated material M3, the mixing section 17 that mixes the defibrated material M3 (the subdivided body M6) and the binder P1 that binds fibers to each other to generate the mixture M7, and the forming section 20 that forms the second web M8 that is the accumulated material of the mixture M7. Accordingly, the second web M8 having a desired thickness distribution can be obtained, and by forming the second web M8, a formed body (sheet S1) having desired characteristics and a desired strength distribution can be obtained.

In addition, the mesh belt 5, which is the accumulating member, transports the second web M8, which is the accumulated material, in the first direction (+x-axis direction) intersecting the vertical direction while accumulating the mixture M7, which is the material dispersed in the air, and the outside air intake port 412 extends in a second direction (y-axis direction) intersecting the first direction (+x-axis direction) when viewed from the vertical direction. Thus, the outside air 200 can be taken in over a wide range in the y-axis direction. Therefore, the second web M8 having a desired thickness distribution can be more effectively obtained.

The plurality of the wind direction plates 7 is provided along the second direction (y-axis direction) so as to be separated from each other. Thus, the outside air 200 can be straightened over a wide range in the y-axis direction. Therefore, the thickness distribution can be controlled more finely.

The wind direction plates 7 may be provided along a direction other than the y-axis direction.

The plurality of wind direction plates 7 is divided into the first wind direction plate group 70A and the second wind direction plate group 70B positioned on the sides opposite to each other with respect to the center of the chamber 4 in the second direction (y-axis direction), and the wind direction plates 70A in the first wind direction plate group 7A and the wind direction plates 70B in the second wind direction plate group 7B are inclined in the directions opposite to each other. As a result, much more sparsity and density of the air are generated in the chamber 4, and the second web M8 having a desired thickness distribution can be more effectively obtained.

Note that the wind direction plates 7A and the wind direction plates 7B may be inclined in the same direction.

The outside air intake port 412 and the wind direction plates 7 are provided on the +x-axis side (first direction side) with respect to the supply port 411. This makes it easy to adjust a direction of the airflow, control a fall position of the mixture M7 in the middle of falling, and more effectively obtain the second web M8 having a desired thickness distribution.

The desired thickness distribution is usually a uniform thickness distribution, but is not limited thereto.

### Second Embodiment

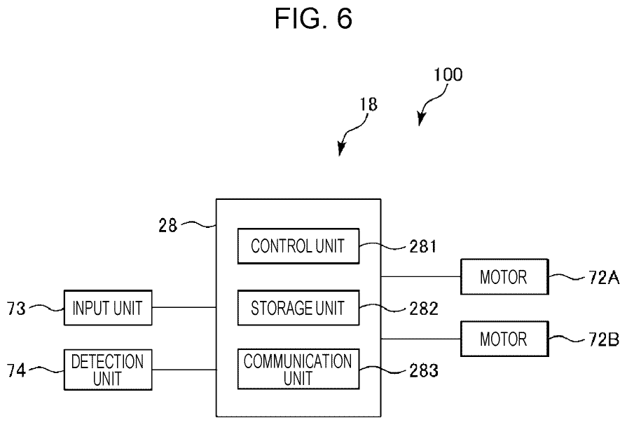

FIG. 5 is an enlarged view of the wind direction plate included in the accumulation device according to the second embodiment of the present disclosure. FIG. 6 is a block diagram of the accumulation device according to the second embodiment of the present disclosure.

Hereinafter, the accumulation device and the method for producing a fiber body according to the second embodiment of the present disclosure will be described below with reference to FIGS. 5 and 6. Differences from the first embodiment will be mainly described below and the description of the same matters will not be repeated.

As shown in FIG. 5, the accumulation device 18 according to the present embodiment includes a rotation support portion 71 that rotatably supports each wind direction plate 7A and each wind direction plate 7B (not shown) around the x-axis. The rotation support portion 71 is a columnar member extending in the x-axis direction, and although not shown, is disposed inside the support member 8. In addition, the rotation support portion 71 supports an end portion of the wind direction plate 7 on the +z-axis side, and the wind direction plate 7 is rotatable to a position indicated by a solid line in FIG. 5, a position indicated by a two-dot chain line in FIG. 5, or the like. Therefore, it is possible to adjust the inclination angle θ of each wind direction plate 7A and each wind direction plate 7B (not shown) with respect to the vertical direction. Therefore, the second web M8 having a desired thickness distribution can be obtained. In addition, it is possible to correspond to various thickness distributions, enabling excellent versatility.

Further, as shown in FIG. 6, the accumulation device 18 has a motor 72A and a motor 72B as a driving unit connected to the rotation support portion 71 and generate a driving force for rotating each wind direction plate 7A and each wind direction plate 7B (not shown). The motor 72A collectively and rotationally drives the wind direction plates 70A of the first wind direction plate group 7A, and the motor 72B collectively and rotationally drives the wind direction plates 70B of the second wind direction plate group 7B. The wind direction plates 70A of the first wind direction plate group 7A and the wind direction plates 70B of the second wind direction plate group 7B may be collectively and rotationally driven by one motor, or each of the wind direction plates 70A of the first wind direction plate group 7A and each of the wind direction plates 70B of the second wind direction plate group 7B may be connected to a motor and independently and rotationally driven at an individual angle.

The motor 72A and the motor 72B are electrically coupled to the control device 28. The control device 28 can adjust a rotation angle (inclination angle θ) of the wind direction plates 7A of the first wind direction plate group 70A and the wind direction plates 7B of the second wind direction plate group 70B by controlling a power-on condition to the motor 72A and the motor 72B via a motor driver (not shown).

The accumulation device 18 further includes an input unit 73 and a detection unit 74.

The input unit 73 includes, for example, a keyboard, a mouse, a touch panel, and the like, and a user inputs various kinds of information using the input unit 73. The various kinds of information include, for example, information on a desired thickness distribution of the second web M8, information on an angle of rotation, information on a type of the raw material M1, and the like. Input information is transmitted to the control device 28 as an electric signal. The storage unit 282 of the control device 28 stores data such as calibration curves, tables, relational expressions, and the like indicating relationship between the information input from the input unit 73 in advance and the power-on condition to the motor 72A and the motor 72B, and the control unit 281 of the control device 28 controls the power-on condition to the motor 72A and the motor 72B based on the information input from the input unit 73. Thus, the inclination angle θ of the wind direction plates 7A and the wind direction plates 7B with respect to the vertical direction can be adjusted according to the information input by the user.

As described above, in the present embodiment, the inclination angle θ of the wind direction plates 7 with respect to the vertical direction can be adjusted. Thus, the second web M8 having a desired thickness distribution can be obtained. In addition, it is possible to correspond to various thickness distributions, enabling excellent versatility.

In addition, the accumulation device 18 includes the rotation support portion 71 which rotatably supports the wind direction plates 7A and the wind direction plates 7B, and the motor 72A and the motor 72B as the driving unit which generates the driving force for rotating the wind direction plate 7A and the wind direction plate 7B. Thus, the second web M8 having a desired thickness distribution can be easily obtained.

The accumulation device 18 also has the detection unit 74 for detecting a thickness of the second webs M8, that is, a thickness of the mixture M7 as a material accumulated on the mesh belt 5. The detection unit 74 may be an optical type, a capacitance type, or a contact type. The detection unit 74 is electrically coupled to the control device 28, and information on the thickness (information on the thickness distribution) of the second web M8 detected by the detection unit 74 is transmitted to the control device 28 as an electric signal.

The control unit 281 of the control device 28 controls the power-on condition to the motor 72A and the motor 72B based on the information on the thickness of the second web M8 detected by the detection unit 74. Alternatively, as described above, the control unit 281 of the control device 28 controls the power-on condition to the motor 72A and the motor 72B based on both the information input from the input unit 73 in advance and the information on the thickness of the second web M8 detected by the detection unit 74. The storage unit 282 stores data such as calibration curves, tables, relational expressions, and the like indicating relationship between the power-on condition to the motor 72A and the motor 72B and the information on the thickness of the second web M8 detected by the detection unit 74. According to such a configuration, it is possible to generate the second web M8 based on the information input from the input unit 73 and to check whether the thickness distribution of the generated second web M8 is a desired thickness distribution. Therefore, when the thickness distribution of the generated second web M8 is not a desired thickness distribution, the thickness distribution of the second web M8 can be brought closer to the desired thickness distribution by adjusting the power-on condition to the motor 72A and the motor 72B. Therefore, the second web M8 having a desired thickness distribution can be more reliably obtained.

As described above, the accumulation device 18 includes the detection unit 74 which detects the thickness of the mixture M7 as a material accumulated on the mesh belt 5 as the accumulating member, and the control unit 281 which controls the operation of the motor 72A and the motor 72B as the driving unit based on a detection result of the detection unit 74. This makes it possible to more reliably obtain the second web M8 having a desired thickness distribution.

Although the accumulation device and the method for producing a fiber body according to the present disclosure have been described with reference to the embodiments shown in the drawings, the present disclosure is not limited thereto, and each section and each step constituting the accumulation device and the method for producing a fiber body can be replaced with any structure and step that can exhibit the same function. In addition, any component or step may be added to the accumulation device and the method for producing a fiber body. Further, the accumulation device and the method for producing a fiber body of the present disclosure may be a combination of the characteristics of the respective embodiments.

For example, the number of the outside air intake port 412 is not limited to two, and the outside air intake port 412 may be integrated into one or divided into three or more.

In addition, the detection unit 74 may perform detection after the second web M8 is formed, and may be provided outside the accumulation device 18. For example, a sensor that reads a distribution of the thickness or density of the fiber body after being cut by the cutting section 21 may be provided.

The wind direction plates 7A and the wind direction plates 7B may be fixed as in the first embodiment, or the inclination angle θ may be changed by one or a plurality of motors as in the second embodiment, or the inclination angle θ may be changed by human power, for example, such that the user directly touches and moves the wind direction plates 7A and the wind direction plates 7B. Each of the wind direction plates may have the same inclination angle θ, or the inclination angle θ may be different for each wind direction plate.

The forming section 20 only needs to arrange the accumulated material into a desired shape, and the cutting section 21 is not necessarily be included if, for example, cutting is not necessary. If sewing is desired, a sewing machine is also included in the forming section 20.

What is claimed is:

1. An accumulation device comprising:
a supply pipe for supplying a material containing fibers;
a chamber for dispersing the material supplied from the supply pipe in air;
an accumulating member provided vertically below the chamber for accumulating the material dispersed in the air to generate an accumulated material; and
a suction section for sucking air from vertically below the accumulating member through the accumulating member,
the chamber including:
a supply port to which the supply pipe is coupled,
an outside air intake port provided at a position different from the supply port for taking in outside air, and
at least one wind direction plate for changing a flow of the outside air taken in from the outside air intake port.

2. The accumulation device according to claim 1, wherein
the accumulating member transports the accumulated material in a first direction intersecting a vertical direction while accumulating the material dispersed in the air, and
the outside air intake port extends in a second direction intersecting the first direction when viewed from the vertical direction.

3. The accumulation device according to claim 2, wherein
a plurality of the wind direction plates is provided in the second direction.

4. The accumulation device according to claim 3, wherein
the plurality of the wind direction plates is divided into a first wind direction plate group and a second wind direction plate group that are positioned on sides opposite to each other with respect to a center of the chamber in the second direction, and
the wind direction plates in the first wind direction plate group and the wind direction plates in the second wind direction plate group are inclined in directions opposite to each other.

5. The accumulation device according to claim 4, wherein
an inclination angle θ of the wind direction plates with respect to the vertical direction is more than 0° and less than 45°.

6. The accumulation device according to claim 2, wherein
the outside air intake port and the wind direction plate are provided on the first direction side with respect to the supply port.

7. The accumulation device according to claim 1, wherein
an inclination angle θ of the wind direction plate with respect to the vertical direction is adjustable.

8. The accumulation device according to claim 7, wherein
an inclination angle θ of the wind direction plate with respect to the vertical direction is adjustable to an angle between more than 0° and less than 45°.

9. The accumulation device according to claim 7, further comprising:
a rotation support portion that rotatably supports the wind direction plate; and
a driving unit that generates a driving force for rotating the wind direction plate.

10. The accumulation device according to claim 9, further comprising:
a detection unit that detects a thickness of the material accumulated on the accumulating member; and
a processor that controls an operation of the driving unit based on a detection result of the detection unit.

11. The accumulation device according to claim 1, further comprising:
a defibrating section that defibrates a fiber material to generate a defibrated material;
a mixing section that mixes the defibrated material and a binder binding the fibers to each other to generate a mixture; and
a forming section that forms the accumulated material of the mixture.

12. A method for producing a fiber body comprising:
supplying a material containing fibers into a chamber;
accumulating the material on the accumulating member to generate an accumulated material by sucking while dispersing the material in air in the chamber; and
producing a fiber body by forming the accumulated material, wherein
in the accumulating, outside air is taken in from an outside air intake port provided in the chamber, and a flow of air in the chamber is adjusted by changing the flow of the outside air taken in from the outside air intake port, and a thickness distribution of the accumulated material on the accumulating member is adjusted.
